(19) United States
(12) Patent Application Publication
(10) Pub. No.: US 2019/0295503 A1
(43) Pub. Date: Sep. 26, 2019

(54) APPARATUSES, SYSTEMS, AND METHODS FOR DISPLAYING MIXED BIT-DEPTH IMAGES

(71) Applicant: Oculus VR, LLC, Menlo Park, CA (US)

(72) Inventors: Andrew John Ouderkirk, Redmond, WA (US); Jasmine Soria Sears, Redmond, WA (US); James Ronald Bonar, Redmond, WA (US); Warren Andrew Hunt, Woodinville, WA (US); Behnam Bastani, San Jose, CA (US)

(21) Appl. No.: 16/004,964

(22) Filed: Jun. 11, 2018

Related U.S. Application Data
(60) Provisional application No. 62/646,624, filed on Mar. 22, 2018.

(51) Int. Cl. G09G 5/04; G06F 3/01; G09G 5/00

(52) U.S. Cl. CPC G09G 5/04; G06F 3/013; G09G 5/006; G09G 2340/02; G09G 2320/0686; G09G 2354/00; G09G 2330/021; G09G 2340/06

(57) ABSTRACT

The apparatus may include a display device that includes an integral display which receives bit-depth assignment data and configures, based on the bit-depth assignment data, the integral display to display image data at differing bit depths within various display regions of the integral display. This may cause the display device to consume a lower proportion of image data to drive display regions of the integral display that are configured to display image data at lower bit depths and maintain higher image quality within display regions of the integral display that are configured to display image data at higher bit depths. The apparatus may also reconfigure the integral display in response to receiving updated bit-depth assignment data. Various other methods, systems, and computer-readable media are also disclosed.

### CROSS REFERENCE TO RELATED APPLICATION

This application claims the benefit of U.S. Provisional Application No. 62/646,624, filed 22 Mar. 2018, the disclosures of which are incorporated, in their entirety, by this reference.

### BACKGROUND

Virtual reality systems frequently use head-mounted displays as part of presenting images of a virtual world to a user. To maintain the immersive nature of a virtual world, head mounted displays may have strict requirements for display brightness, resolution, frame-rate, and color gamut, among other features. However, the resource-intensive operations performed by head-mounted displays may result in high levels of power consumption and heat generation, potentially leading to short battery life and/or user discomfort.

One aspect affecting heat generation and power consumption includes processing data for the display controllers. Transmitting and processing display data may consume a significant amount of power, especially when presenting complex images as part of displaying a virtual world. The disclosed subject matter accordingly identifies and addresses a need for improved systems and methods to reduce image data handled by display controllers.

### SUMMARY

As will be described in greater detail below, the instant disclosure describes apparatuses, systems, and methods for enabling display devices to display mixed bit-depth images to end users, thereby reducing the amount of image data required to drive the display devices. In some embodiments, an apparatus for displaying mixed bit-depth images may include a display device. Such a display device may include an integral display that (A) receives bit-depth assignment data that specifies differing bit depths for corresponding display regions of the integral display, and (B) configures, based on the bit-depth assignment data, the integral display to display image data at the differing bit depths within the corresponding display regions of the integral display. Configuring the integral display device in this manner may cause the display device to consume a lower proportion of image data to drive a display region of the integral display that is configured to display image data at a lower bit depth while maintaining higher image quality within a display region of the integral display that is configured to display image data at a higher bit depth. Furthermore, the display device may reconfigure the integral display in response to receiving updated bit-depth assignment data.

In some embodiments, the above-described apparatus may include a gaze-tracking element that determines a direction of a user's gaze as the user views the display device and provides, based at least in part on the direction of the user's gaze, the updated bit-depth assignment data. In such embodiments, the gaze-tracking element may contribute to the bit-depth assignment data to specify that a first bit depth for a first display region of the integral display is higher than a second bit depth for a second display region of the integral display based at least in part on the gaze-tracking element determining that the user's gaze is closer to the first display region than to the second display region.

In some examples, a display region of the integral display that is configured to display image data at the lower bit depth may include a region that is adjacent to and concentric with a display region that is configured to display image data at the higher bit depth.

In certain embodiments, the display device may reconfigure the integral display based at least in part on a predetermined bit-depth mask that specifies a predetermined bit depth for each display region.

In some examples, the bit-depth assignment data may specify a granular bit depth for an indicated display region of the integral display. This granular bit depth may specify a first sub-pixel bit depth for a first category of sub-pixels in the indicated display region, and a second sub-pixel bit depth for a second category of sub-pixels in the indicated display region. This second sub-pixel bit depth may be different from the first sub-pixel bit depth.

In further embodiments, the bit-depth assignment data may specify a spatially dithered bit depth for an indicated display region of the integral display. The spatially dithered bit depth may specify a first bit depth for a first subset of display elements within the indicated display region, and a second bit depth for a second subset of display elements within the indicated display region, wherein the second bit depth is different from the first bit depth and wherein the second subset of display elements are interspersed among the first subset of display elements according to an ordered dithering pattern.

Additionally or alternatively, the bit depth assignment data may specify a temporally dithered bit depth for an indicated display region of the integral display. Such a temporally dithered bit depth may specify, over a dithering period, a first bit depth for a subset of display elements within the indicated display region within a first subset of display frames displayed during the dithering period, and a second bit depth for the subset of display elements within the indicated display region within a second subset of display frames displayed during the dithering period, wherein the second subset of display frames are interspersed with the first subset of display frames during the dithering period according to a dithering pattern.

In some embodiments, a system for displaying mixed bit-depth images may include (i) a display device that includes an integral display that is configured to display mixed bit-depth images to a user, (ii) a driver element that generates bit-depth assignment data that specifies differing bit depths for corresponding display regions of the integral display, (iii), a reception element, communicatively coupled to the display device, that receives the bit-depth assignment data, and (iv) a configuration element, communicatively coupled to the display device and the reception element, that configures, based at least in part on the bit-depth assignment data, the integral display to display image data at the differing bit depths within the corresponding display regions of the integral display. Configuring the integral display in this fashion may cause the integral display to (A) consume a lower proportion of image data to drive a display region of the integral display that is configured to display image data at a lower bit depth, and (B) maintain higher image quality within a display region of the integral display that is configured to display image data at a higher bit depth. Moreover, the configuration element may reconfigure the integral display in response to receiving updated bit-depth assignment data.

In some embodiments, the above-described system may further include a bit-reduction element that receives an original image for display by the display device and reduces the original image to have varying bit depths according to the bit-depth assignment data before transmitting the bit-reduced image to the display device. In these embodiments, the data size of the bit-reduced image may be less than a data size of the original image.

In some examples, the system may further include a second integral display and a head mount that is coupled to both the integral display and the second integral display such that when the head mount is worn by a user, the head mount holds the integral display in front of the user's left eye and holds the second integral display in front of the user's right eye.

A method for assembling the above-described apparatus and/or system may include (i) coupling, to a display element that is configured to display mixed bit-depth images, a reception element that is configured to receive bit-depth assignment data that specifies differing bit depths for corresponding display regions of the display element, (ii) establishing a communicative connection between the reception element and a driver element that generates the bit-depth assignment data by configuring differing bit depths for corresponding regions of the mixed bit-depth images, and (iii) coupling the display element and the reception element to a configuration element that (A) configures, based at least in part on the bit-depth assignment data, the display element to display the mixed bit-depth images according to an arrangement of regions specified by the bit-depth assignment data, and (B) reconfigures, based at least in part on the reception element receiving updated bit-depth assignment data from the driver element, the display element to display the mixed bit-depth images according to an updated arrangement of regions specified by the updated bit-depth assignment data.

In some examples, the method may include coupling a head mount to the display element that, when worn by a user, holds the display element within a user's field of view. Additionally or alternatively, the method may include establishing a communicative connection between the driver element and a gaze-tracking element that determines a direction of a user's gaze as the user views images displayed by the display element. The driver element may generate the bit-depth assignment data based at least in part on the direction of the user's gaze.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings illustrate a number of exemplary embodiments and are a part of the specification. Together with the following description, these drawings demonstrate and explain various principles of the instant disclosure.

FIG. 1 is a schematic diagram of an example display apparatus that displays mixed bit-depth images.

FIG. 2 is an additional schematic diagram of an example display apparatus that displays mixed bit-depth images.

FIG. 3 is a schematic diagram of a single pixel that includes four sub-pixels.

FIG. 4 is a schematic diagram of an example pixel array that may be configured to display mixed bit-depth images.

FIG. 5 is an example image presented at a high bit-depth.

FIG. 6 is an example image presented at a low bit-depth.

FIG. 7 is a schematic diagram of an example bit-depth mask that may be applied to an image as part of generating a mixed bit-depth image.

FIG. 8 is an example mixed bit-depth version of the image of FIG. 6, generated using a bit-depth mask of FIG. 7.

FIG. 9 is a schematic diagram of an additional example bit-depth mask that incorporates a bit-depth floor.

FIG. 10 is an additional example mixed bit-depth version of the image of FIG. 6 that incorporates the bit-depth floored mask of FIG. 9.

FIG. 11 is a schematic diagram of the bit-depth mask of FIG. 10 that has been shifted to track with a user's gaze.

FIG. 12 is a block diagram of an example system for displaying mixed bit-depth images.

FIG. 13 is a flow diagram of an exemplary method for assembling an apparatus to display mixed bit-depth images.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to apparatuses, systems, and methods for displaying mixed bit-depth images. As will be explained in greater detail below, embodiments of the instant disclosure may divide the display area of an electronic display into various regions that present corresponding portions of an image at varying bit depths. For example, the apparatuses, systems, and methods described herein may track the direction of a user's gaze and process images to be presented to the user to have a central area corresponding to the direction of the user's gaze to be displayed at a high bit-depth while concentric regions moving outward from the central region are displayed at different (e.g., progressively lower) bit depths. Moreover, the display device may continuously update the distribution and/or bit depths of the regions based on receiving revised bit-depth assignment information, which may be based at least in part on the direction of the user's gaze.

The visual acuity of the human eye generally decreases as a function of angle from the fovea (center of view). Therefore, peripheral regions of a user's field of view may process images at a substantially lower resolution than the central regions of the user's field of view. The apparatuses, systems, and methods described herein may take advantage of this uneven visual processing by presenting high-quality portions of images to the center of a user's field of view and presenting reduced quality images to the peripheral regions of the user's field of view. The reduction in bit depth for a particular region of an image may correspond to the distance of the region from a focal region (e.g., a point that corresponds to the center of a user's gaze) of the image.

Displaying these mixed bit-depth images may improve the functioning of an electronic display system by reducing image data handled by display controllers versus displaying images that are not mixed bit-depth. Moreover, by adjusting the positions of regions containing higher bit depth within a mixed bit-depth image, the apparatuses and methods described herein may preserve user perception of image quality while reducing the amount of data that must be processed to display images on the electronic display devices. Minimizing the amount of data that must be processed and transmitted may also afford display systems a variety of benefits, such as reductions in power consumption and/or heat generation. Minimizing the amount of data that must be processed may additionally or alternatively reduce video stutter or processing lag.

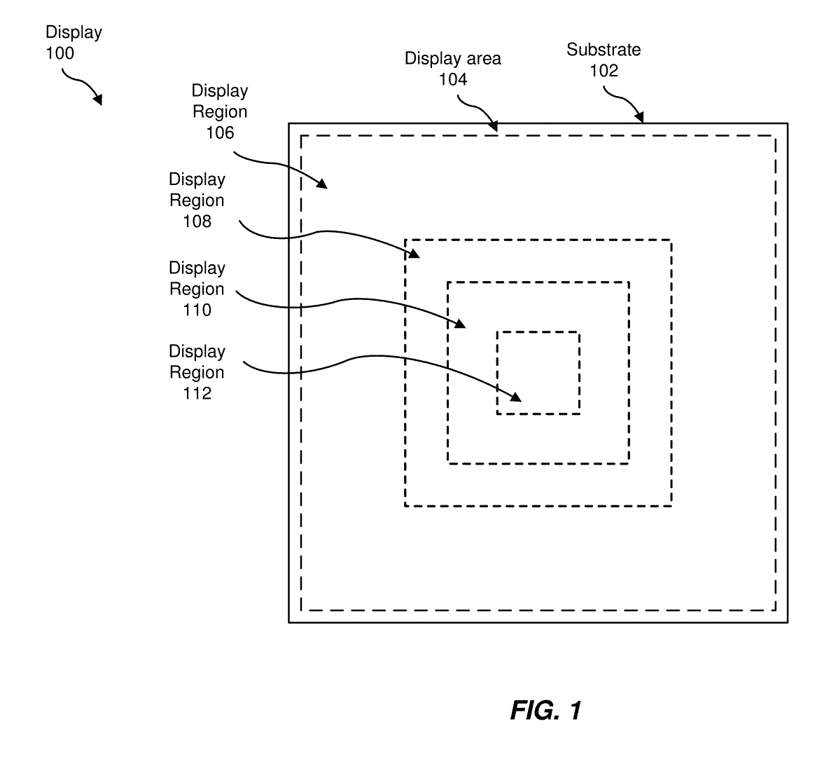

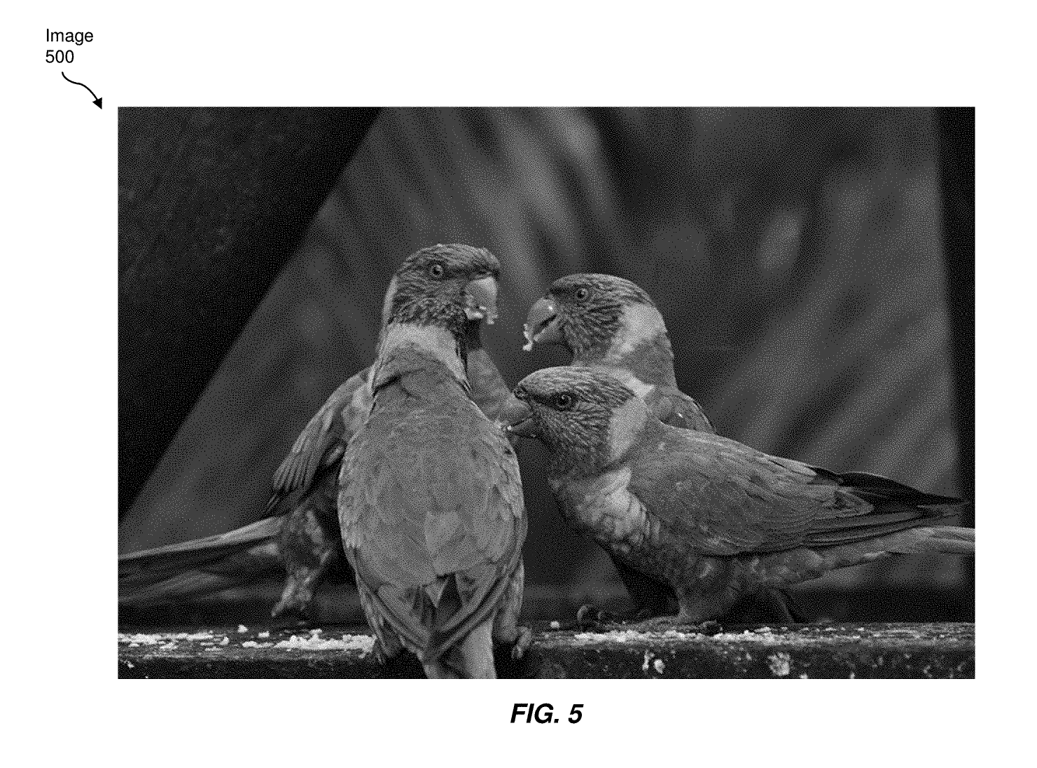

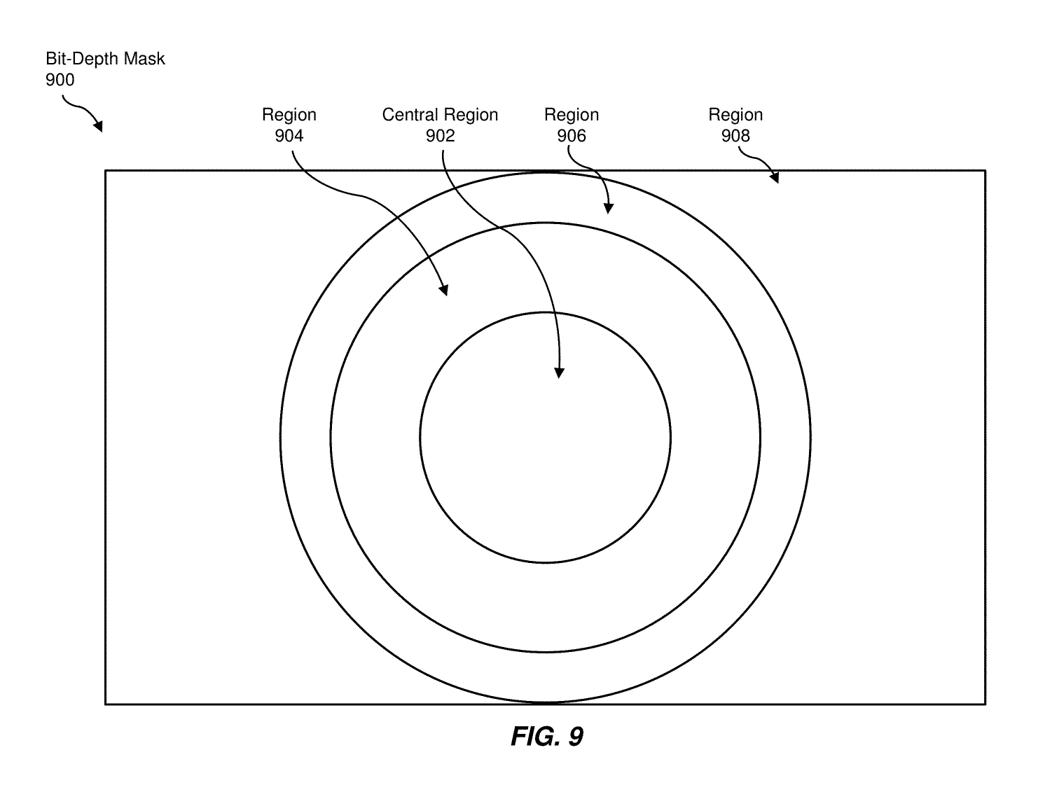

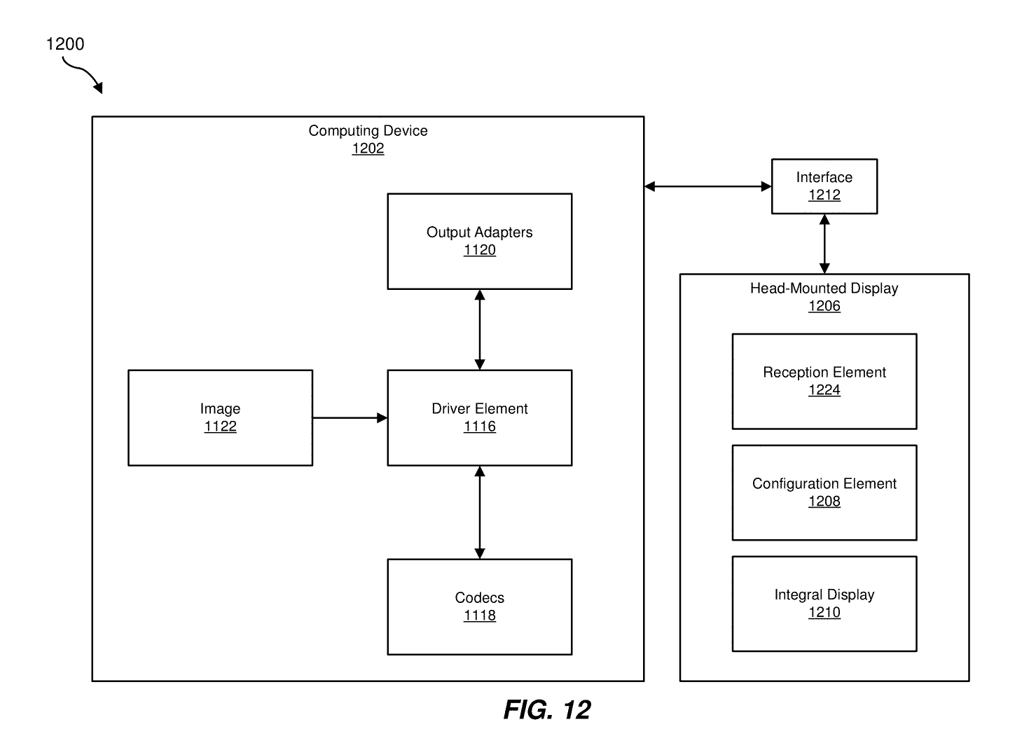

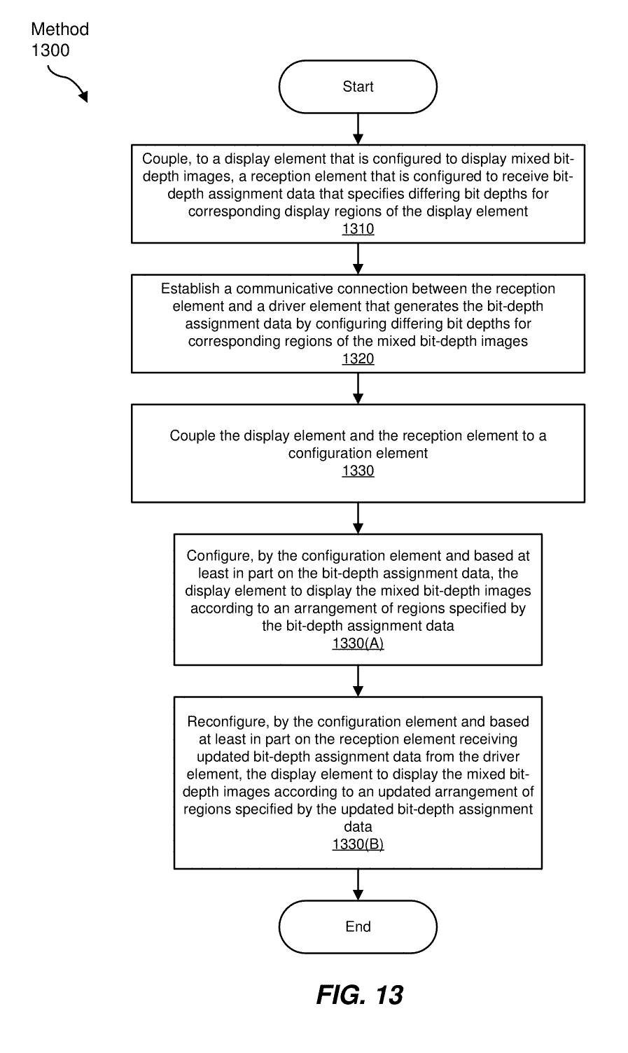

The following will provide, with reference to FIGS. 1-4, detailed descriptions of displays and display components for displaying mixed bit-depth images. Example images, bit-depth masks, and bit-depth reduction outputs will be described in connection with FIGS. 5-11. The following will also provide, with reference to FIG. 12, detailed descriptions of example systems for displaying mixed bit-depth images. Moreover, detailed descriptions of an example method for assembling a display device capable of displaying mixed bit-depth images will be provided in connection with FIG. 13.

FIG. 1 is a schematic diagram of an example display 100 that is capable of displaying mixed bit-depth images. Display 100 may include a substrate 102 that connects display 100 to other components of an apparatus and/or system, as will be described in greater detail below. Moreover, display 100 may include a display area 104 that displays images to users viewing display 100. Display area 104 may be divided into multiple display regions, illustrated in FIG. 1 as display regions 106, 108, 110, and 112.

Display 100 may be included as part of an apparatus that receives bit-depth assignment data that specifies differing bit depths for corresponding display regions of an integral display. In these embodiments, the bit-depth assignment data may specify differing bit depths for display regions 106, 108, 110, and/or 112. Regions that are not specified in the bit-depth assignment data may be configured to display corresponding image portions at a default bit depth. Various components of the apparatus, such as a configuration component, display driver, and the like, may then configure, based on the bit-depth assignment data, display 100 to display image data at the differing bit depths within the corresponding display regions of display 100. For example, bit-depth assignment data may specify that display region 112 is to display image data at 8 bits of depth, display region 110 is to display image data at 7 bits of depth, display region 108 is to display image data at 6 bits of depth, and display region 106 is to display image data at 5 bits of depth. As will be described in greater detail below, dividing display area 104 into regions of varying bit depth in this manner may cause display 100 to consume a lower proportion of image data to drive display regions that are configured to display image data at lower bit depths while maintaining higher image quality within display regions that are configured to display image data at higher bit depths.

In some examples, the term “bit depth” as used herein may refer to a quantity of information used to display an image. For example, the higher the bit depth of an image, the more colors may be used to represent that image. As a specific example, an image with a bit depth of 8 may use 8 bits of data to represent each pixel in an image, thereby allowing display devices driving those pixels to select from any of 256 (i.e., 2̂8) colors. As an additional example, an image with a bit depth of 1 may be a monochrome image due to a single bit of data being used to drive each pixel only being able to represent two values, “1” and “0.” As may be appreciated from the preceding description, driving displays and/or display regions higher bit depths may allow those displays and/or display regions to present higher quality images to users. However, these higher quality images may be delivered at the cost of requiring more data to drive the display and/or display regions. Conversely, lower bit-depth images may represent lower quality but may require correspondingly less data to drive the display and/or display regions.

Bit-depth assignment data may specify a variety of information as part of a bit depth for a particular region. For example, and as described above, a bit depth for a particular region may describe an overall bit depth that is applied to all pixels in that region. In further examples, and as will be described in greater detail below, a bit depth may specify granular bit depths for groups or categories of sub-pixels within the region. Moreover, the bit-depth assignment data may specify bit depths for groups of pixels per a spatial dithering pattern and/or specify bit depths for groups of image frames per a temporal dithering pattern.

In some embodiments, the bit-depth assignment data may include information that details the positioning and/or arrangement of display regions within a display device. In some embodiments, such as display 100 of FIG. 1, an integral display of a display apparatus may be configured with display regions that are configured to display image data at a lower bit depth and are adjacent to and concentric with a central display region that is configured to display image data at a higher bit depth. For example, and with continuing reference to FIG. 1, the bit-depth assignment data has specified that display area 104 be divided into four concentric square-shaped regions corresponding to display regions 106, 108, 110, and 112. Although FIG. 1 illustrates the display regions as concentric squares, display area 104 (and corresponding display areas of other figures described below) may be divided using any suitable shapes (e.g., circles, ovals, rectangles, hexagons, etc.) and/or arrangement of display regions that allows the display to present images of a smaller data size while preserving user perceptions of image quality.

In some examples, the apparatus described herein may receive updates to the bit-depth assignment data. In these cases, the apparatus may reconfigure display 100 in response to receiving the updated bit-depth assignment data. For example, the apparatus may reconfigure display regions 106, 108, 110, and/or 112 to present corresponding portions of an image at updated bit depths. Additionally or alternatively, the updated bit-depth assignment data may include information describing new positions for display regions 106, 108, 110, and/or 112.

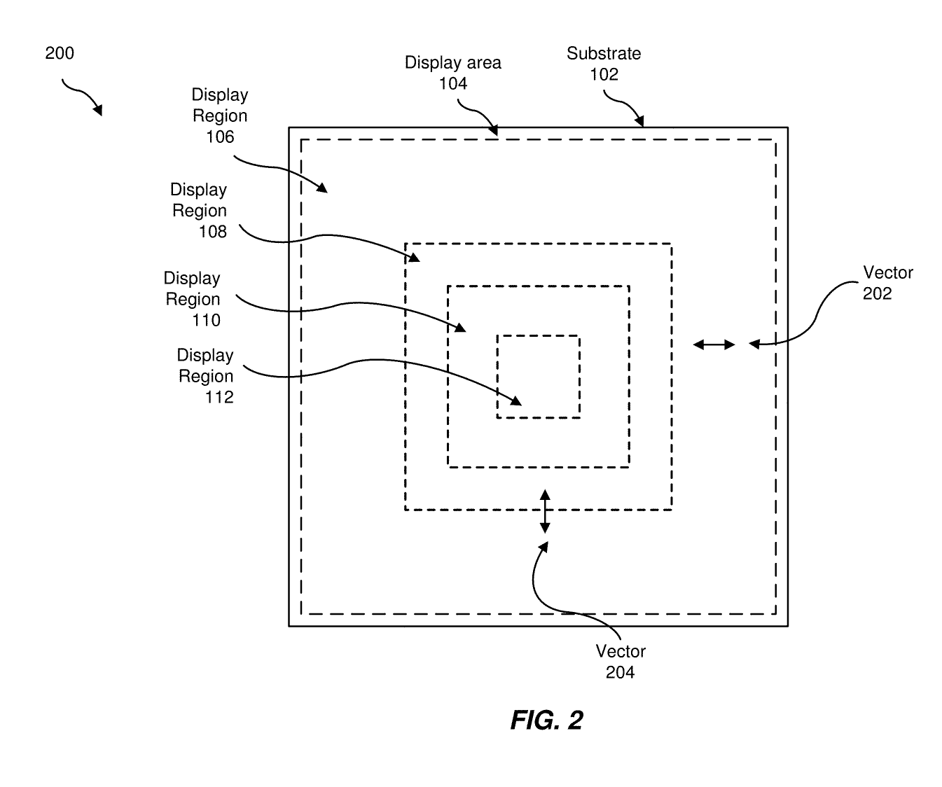

FIG. 2 illustrates an example display 200, in which display 200 may reposition display regions along specified vectors. For example, and as illustrated in FIG. 2, the bit-depth assignment data may include positional information along vectors 202 and/or vector 204 describing a displacement and/or absolute position within display area 104 for display regions 106, 108, 110, and/or 112. The apparatuses, systems, and methods described herein may vary the positions of display regions in response to a variety of factors.

In some embodiments, the bit-depth assignment data may include only a single positional coordinate, such as a two-dimensional coordinate. For example, the bit-depth assignment data may include positional information for a single display region and/or a positional coordinate for the center of a user's gaze. In these embodiments, the positions of various peripheral display regions may be linked to the position of the single coordinate. In the example of FIGS. 1 and 2, display region 112 may represent the central display region, and the position of display region 112 may be controlled by the single coordinate in the bit-depth assignment data. In this example, display regions 106, 108, and 110 may have previously been configured to remain concentric with display region 112, and display 100 may configure the positions of these peripheral display regions based on the position of display region 112 and/or the single positional coordinate.

In some embodiments, the apparatuses, systems, and/or methods described herein may include a gaze-tracking element that determines a direction of a user's gaze as the user views the display device. In these embodiments, the gaze-tracking element may provide, based at least in part on the direction of the user's gaze, information that may be used to generate the bit-depth assignment data. By generating bit-depth assignment data in this manner, display 100 may ensure that the display region(s) displaying the highest quality image data remain centered within the user's field of view. With returning reference to the above-described example in which the positions of the various display regions are linked to a single positional coordinate of the display area, the display device may use the direction of the user's gaze as the single positional coordinate. By tracking the regions configured to display image data at the highest bit depths to remain centered within the user's field of view, the apparatuses, systems, and methods described herein may preserve user perception of image quality while enabling display systems to present regions of images at lower bit depths, thereby reducing the amount of image data required to present images to users.

Additionally or alternatively, the gaze-tracking element may contribute to the bit-depth assignment data to specify that a first bit depth for a first display region of display 100 is higher than a second bit depth for a second display region of display 100 based at least in part on the gaze-tracking element determining that a user's gaze is closer to the first display region than to the second display region. For example, display 100 may be divided into a grid of square-shaped regions. The gaze-tracking element may indicate that the direction of the user's gaze corresponds to a particular region. The bit-depth assignment data may accordingly specify that the bit depth used to drive the region corresponding to the direction of the user's gaze is higher than regions that do not correspond to the direction of the user's gaze. Furthermore, the degree of bit depth reduction for any given region may be based on the distance of that region from the region corresponding to the direction of the user's gaze.

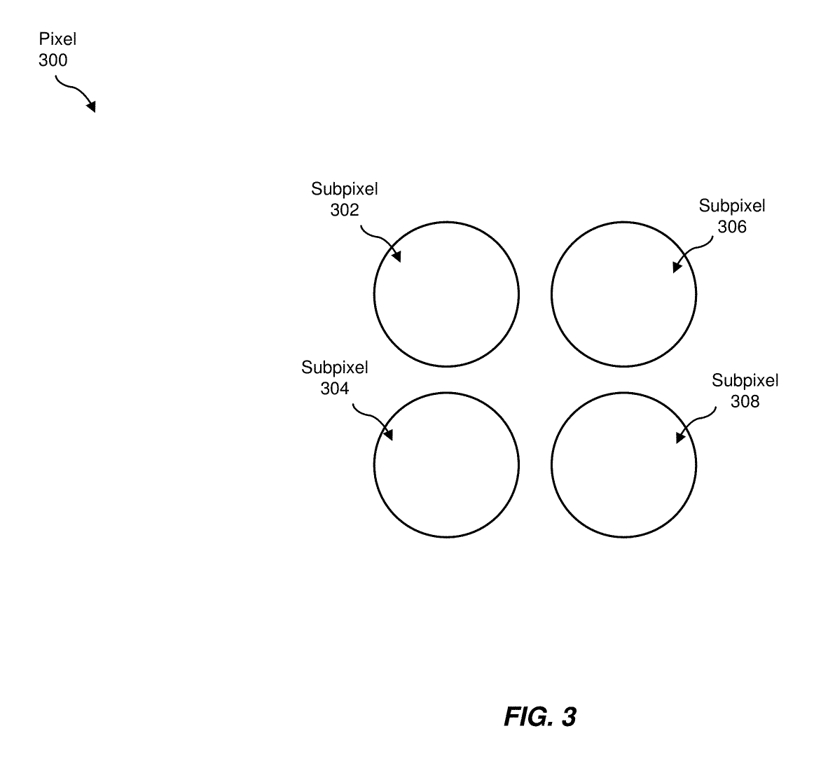

A single pixel within a display may be composed of sub-pixels. An illustrated example of a pixel composed of sub-pixels is provided in FIG. 3. As shown in FIG. 3, a pixel 300 may include four sub-pixels, illustrated here as sub-pixels 302, 304, 306, and 308. Instances of pixel 300 may be repeated across the face of display 100, and each category of sub-pixel may display a single color. For example, sub-pixels 302 and 308 may display varying intensities of blue while sub-pixel 306 displays varying intensities of red and sub-pixel 304 displays varying intensities of green. Although pixel 300 is illustrated in FIG. 3 as including two blue sub-pixels, one red sub-pixel, and one green sub-pixel arranged in a square pattern, display devices may include pixels composed of any suitable number and/or arrangement of sub-pixels. For example, a pixel may include six sub-pixels of various colors arranged in a hexagonal pattern.

In some embodiments, bit-depth assignment data may specify granular bit depths for an indicated display region of an integral display. For example, the bit-depth assignment data may specify that certain sub-pixels should be driven at a high bit depth while other sub-pixels should be driven at a lower bit depth. In some embodiments, a granular bit depth may specify varying bit depths for various categories of sub-pixels within the integral display. For example, the granular bit depth may specify a first sub-pixel bit depth for a first category of sub-pixels in the indicated display region and a second sub-pixel bit depth for a second category of sub-pixels in the indicated display region that is different from the first sub-pixel bit depth. As a specific example, pixels in the indicated display region may be composed of red, green, and blue sub-pixels. In this example, the granular bit depth may specify that red and green sub-pixels are to be driven at 8 bits of color depth, while blue sub-pixels are to be driven at 6 bits of color depth. Bit depth assignment data that specifies a granular bit depth may indicate that blue sub-pixels, such as sub-pixels 302 and 308 in FIG. 3, are to be driven at 6 bits of color depth while other sub-pixels, such as sub-pixels 306 and 304 in FIG. 3, are to be driven at 8 bits of color depth.

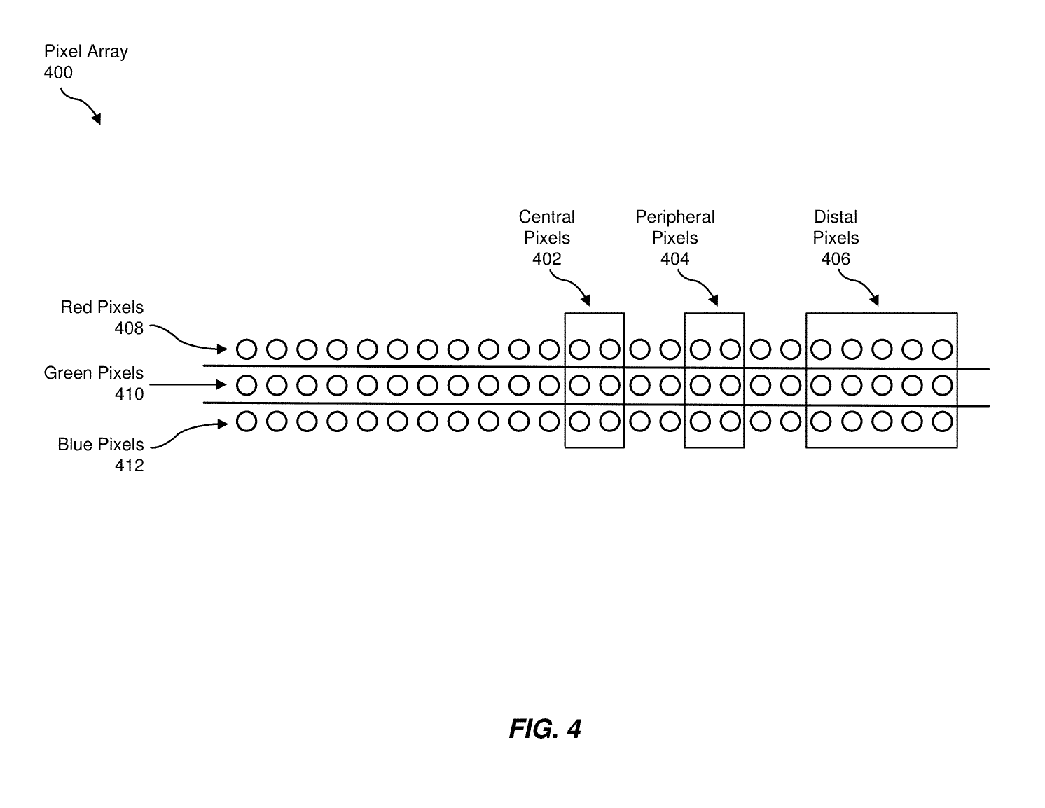

Pixels may be arranged in a variety of ways to form a display. In some embodiments, a display may be composed of a two-dimensional array of pixels. In further embodiments, a display may be a scanned display that employs various optical devices to enable a linear pixel array to present a two-dimensional image to a user. For example, a linear array of pixels may be scanned across a surface to yield a two-dimensional image on the surface. In other words, a single pixel in the linear array may be scanned across the surface to display a row and/or column of pixels on the surface. An illustrated example of a linear pixel array that may be used as part of a scanned display is provided in FIG. 4. Pixel array 400 may be composed of pixels arranged in several groupings. For example, pixel array 400 may include a strip of red pixels 408 along with parallel strips of green pixels 410 and blue pixels 412. Scanned displays may be used in a variety of contexts, such as head-mounted display systems.

In some embodiments, pixel array 400 may be configured to display variable bit-depth images. In these embodiments, the bit depth used to drive a given light source may correspond to the pixel currently being illuminated by that light source. For example, the light sources of pixel array 400 may be driven at a low bit depth when the scanning process is directing light from all or a portion of pixel array 400 to a region of the display that has been designated in the bit-depth assignment data as having a low bit depth. Similarly, the light sources of pixel array 400 may be driven at a high bit depth when the scanning process directs light from all or a portion of pixel array 400 to a region of the display that has been designated in the bit-depth assignment data as having a high bit depth.

As a specific example, the scanning process may, at a particular instant in time, direct light from pixel array 400 to a region of a display such that central pixels 402 are directing light towards a central region that corresponds to the direction of a user's gaze. In this example, the display system may drive central pixels 402 at a high bit depth (e.g., 8 bits of color depth). Peripheral pixels 404 may direct light towards portions of the display that are removed from the central region. The display system may accordingly drive peripheral pixels 404 at a lower bit depth than central pixels, and similarly drive distal pixels 406 at an even lower bit depth than peripheral pixels 404. When the display scanning process directs the light from pixel array 400 to the next portion (e.g., next row or next column of pixels), the display system may update the bit depths being used to drive each light source in pixel array 400 in accordance with the bit-depth assignment data for that portion of the display.

FIG. 5 is an example of an image 500 that may be presented to a user through one or more of the display systems described herein. In the example of FIG. 5, image 500 is being shown at a high bit depth, in this case, at 8 bits of color depth. As will be described in greater detail below, the apparatuses, systems, and/or methods described herein may reduce the bit depth of one or more portions of image 500 and/or configure a display device to display one or more portions of image 500 at a lower bit depth to cause the display device to reduce the amount of image data required to drive the display device while maintaining user perception of overall image quality.

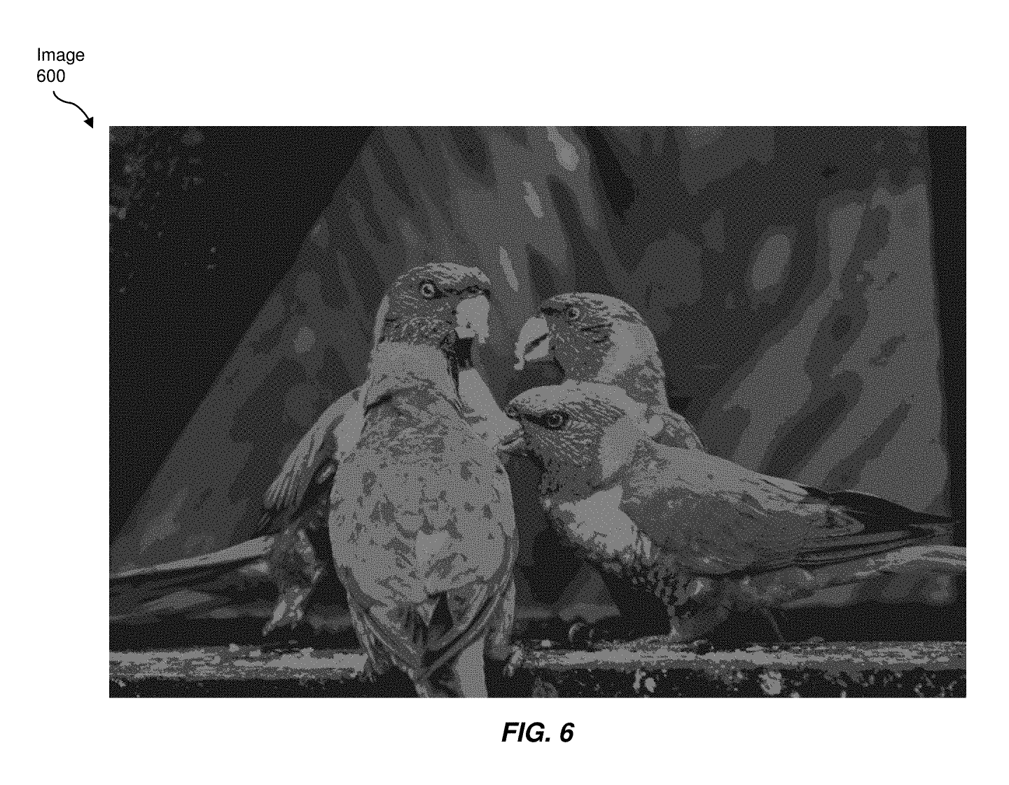

Image 600, illustrated in FIG. 6, is an example result of a reduced bit-depth image. In this example, one or more of the apparatuses, systems, and/or methods described herein may produce image 600 by reducing the bit depth of image 500 from 8 bits of color to 3 bits of color. Although image 600 may include a smaller data size than image 500, image 600 suffers from a correspondingly lower image quality. Furthermore, although image 600 is shown using 3 bits of color depth, the apparatuses, systems, and methods described herein may use any suitable bit depth for driving portions of a display device.

Display systems may determine bit depths for display regions in a variety of ways. In some embodiments, a display system may use pre-determined layouts when generating bit-depth assignment data for display devices. For example, and as will be described in greater detail below, a display system may use a pre-determined bit-depth mask that specifies bit depths for each display region. The display system may select a particular bit mask or other pre-determined layout based on pre-configured settings. These pre-configured settings may specify a default layout to be used in the absence of other instructions, such as a bit-depth mask that has been modeled to work well for a variety of individuals and/or software.

Furthermore, the display system may adjust a pre-determined layout based on contextual information based on analyzing an application. For example, the display system may calibrate a bit-depth mask based on determining that a user's gaze is more likely to rapidly shift when interacting with a particular application such as a video game, while the user's gaze is less likely to rapidly shift when interacting with a different application such as a file browser.

In some embodiments, applications may communicate display requirements to the display system. For example, an application may include configuration settings that allow users to specify or otherwise calibrate display properties for use with that application. As a specific example, an application and/or display system may include a calibration process that allows a particular user to maximize their perception of image quality while also allowing the display system to minimize the total amount of image data required to present images to the user. Such a calibration process may modify the size, shape, position, bit-depth range, bit-depth reduction style (e.g., dithering patterns), and/or any other suitable factor of a bit-depth mask based on the user's interaction with the calibration process.

Moreover, certain embodiments may account for a user's blind spots and further reduce the bit depth of regions corresponding to the user's blind spots. A display system may use a predetermined layout that includes a region presumed to correspond to most users' blind spots and/or include a calibration process that allows users to customize these blind-spot correlated regions.

In some examples, the display properties may include specifications for a bit-depth mask for use with the application. Additionally or alternatively, the display properties may include information that a display system may use to generate a bit-depth mask outside of the application. For example, an application may include display properties that specify a minimum bit depth, a screen refresh rate, a color palette, a hue range, and/or any other suitable information that a display system may use to generate bit-depth masks. In some embodiments, a user may configure the display properties directly. In further embodiments, the display properties may be determined by the application and/or display system without user input.

In some embodiments, display systems may use dynamic calculations to determine the bit depth for a particular region. For example, a display system may base the bit depth used to drive a region of a display based on a function of angle from a designated focal region. The display system may display portions of images corresponding to the designated focal region at a high bit depth while reducing the bit depth for regions that are farther away from the designated focal region. The reduction in bit depth for a given region may be determined in a variety of ways. For example, the display system may reduce the bit depth for regions based on a function of the visual angle of that region from the designated focal region.

In some embodiments, a display system may configure an integral display based at least in part on a predetermined bit-depth mask that specifies predetermined bit depths for each display region. For example, a display system may use a bit-depth mask that specifies bit depths for a variety of regions according to a pre-determined pattern. Display systems may accordingly drive portions of an integral display that correspond to a particular region of the bit-depth mask at the bit depth that is associated with that particular region of the bit-depth mask. For example, if a region of a bit-depth mask indicates a bit depth of 5 bits, the display system may drive the corresponding region of an integral display at a bit depth of 5 bits.

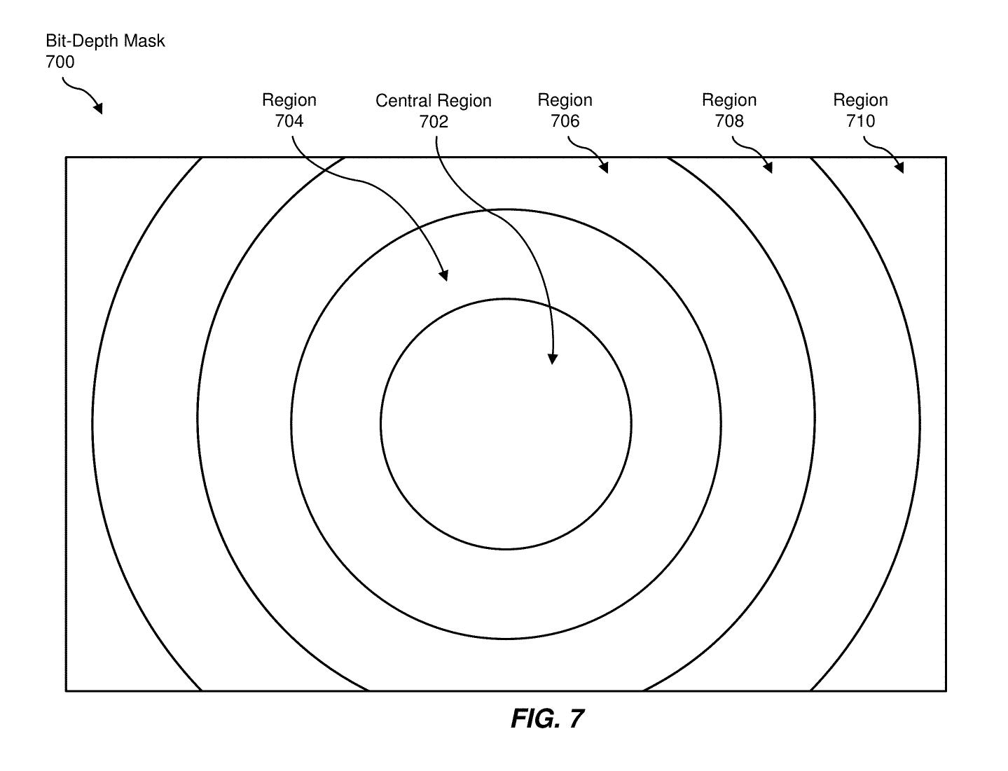

Bit-depth masks may be composed of any suitable pattern and/or layout of regions. For example, a bit-depth mask may be a grid of squares, with each square having an assigned bit depth. Alternatively, a bit-depth mask may be a series of concentric regions, such as the concentric squares illustrated in FIGS. 1 and 2. In further embodiments, a bit-depth mask may incorporate concentric circular regions of fixed width, with each region indicating a progressively lower bit depth as the distance from the central region increases. Additionally or alternatively, the concentric circular regions may vary in size according to a nonlinear mathematical function. For example, regions may be closer together (thus representing a smoother drop-off in bit-depth) near the focal region of the image, thereby reducing distinctions between regions that might be perceived by a user. Such a bit-depth mask may place the designated focal region described above in the center of the pattern, with each successive ring representing a region of progressively lower bit-depth. FIG. 7 illustrates an example bit-depth mask 700 that includes five concentric ring-shaped regions. As shown in FIG. 7, bit-depth mask 700 includes a central region 702 that may represent a region that will be displayed at the highest bit depth, such as at 8 bits of depth. Region 704, the next region out from central region 702, is concentric with central region 702 and may indicate that corresponding image portions should be displayed at a lower bit depth than image portions corresponding to central region 702, such as 7 bits of color depth. This pattern may continue for each successive region of bit-depth mask 700, with regions 706, 708, and 710 indicating bit depths of 6, 5, and 4, respectively. Although FIG. 7 illustrates a bit-depth mask incorporating concentric shapes of uniform spacing, bit-depth masks may incorporate any suitable pattern, such as nonlinear spacing of the regions.

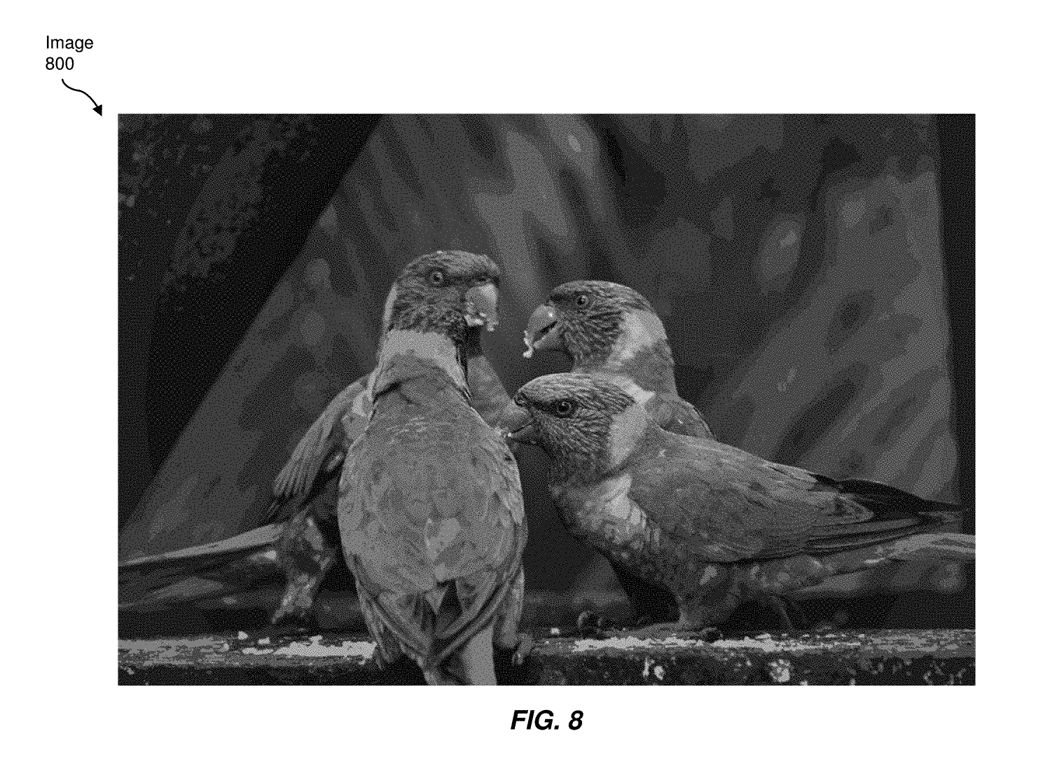

FIG. 8 is an example output image 800 generated by applying bit-depth mask 700 to an original image, in this case image 500 as shown in FIG. 5. Image 800 preserves high bit depth in regions of the image that correspond to the high bit-depth regions of bit-depth mask 700, i.e., central region 702, with progressively lower bit depths in regions that are farther away from ventral region 702.

Although the above-described example starts with central region 702 at 8 bits of color depth and steps the bit depth down by one for each successive region moving outward, other bit-depth masks may include more or fewer regions and scale the bit-depth according to any suitable scheme. For example, a bit-depth mask may reduce the bit depth of each successive region in a linear fashion (e.g., 8, 7, 6, 5, 4). Alternatively, a bit-depth mask may reduce the bit depth of each successive region non-linearly (e.g., 64, 32, 16, 8, 4). Regions displayed at a low bit depth may suffer from visual artifacts. For example, the upper left corner of image 800 shows distinct visual artifacts, including a visible boundary between two different image regions that are displayed at different bit depths.

In order to reduce visual artifacts caused by displaying portions of an image at very low bit depths, the apparatuses, systems, and/or methods described herein may enforce a bit-depth floor. For example, a display system may enforce a minimum bit depth for an image. This minimum bit depth may apply to pixels as a whole and/or to sub-pixels of an integral display. In some embodiments, a display system may use bit-depth masks that incorporate a bit-depth floor. For example, a bit-depth mask may be configured such that image data processed using the bit-depth mask is displayed at a minimum of 5 bits of color depth. FIG. 8 illustrates an example bit-depth mask 900 that incorporates a bit-depth floor. Bit-depth mask 900 includes a central region 902, analogous to central region 702 of bit-depth mask 700, with further concentric regions displaying progressively lower bit depths down to a bit-depth floor of 5. In this example, bit-depth mask 900 includes three additional regions, illustrated as regions 904, 906, and 908, which may represent regions configured to display image data at bit depths of 7, 6, and 5, respectively. Although implementing a bit-depth floor may increase the amount of image data required to display a mixed bit-depth image, implementing the bit-depth floor may reduce the presence of visual artifacts that may negatively affect user perception of image quality.

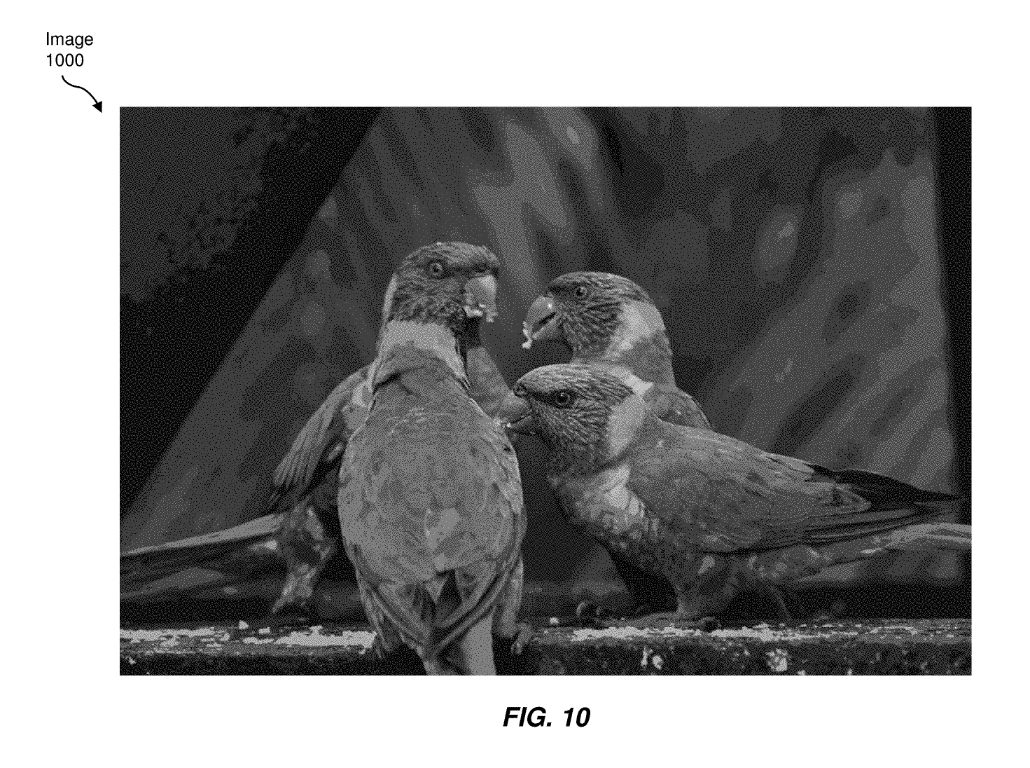

FIG. 10 illustrates an example image 1000 that represents an output of applying bit-depth mask 900, which implements a bit-depth floor, to image 500. As with image 800 in FIG. 8, image 1000 preserves high bit depth near the center of the image. However, image 1000 displays with a minimum bit depth of 5, resulting in significantly fewer visual artifacts. In particular, the upper left corner of image 1000 does not display as many visual artifacts as the upper left corner of image 800.

Although the above-described examples are directed to the application of a fixed bit-depth mask to an image, the systems and methods described herein may apply bit-depth reduction patterns to original images in other suitable fashions. In some embodiments, a driver element may specify display guidelines (rather than a strict layout, such as might be described by a bit-depth reduction mask) that describe how a configuration element should reduce the bit-depth of a displayed image. For example, a driver element may specify a mathematical function describing a bit-depth pattern for an image. As a specific example, the driver element may specify a mathematical function describing a bit-depth falloff curve relative to a focal region of the original image. This mathematical function may be a linear function or a nonlinear function (e.g., depending on the layout of the integral display). Additionally or alternatively, a driver element may specify a texture map of bit-depth percentages (i.e., percentages of the original bit depth at which various image regions should be displayed). A display element, configuration element, and/or any other suitable component of a display system may apply these mathematical functions and/or texture maps to an original image in any suitable fashion. For example, a configuration element may break an image into a pattern of regions and assign bit-depths to each region based on a mathematical function. The configuration element may optionally blend and/or dither these regions to preserve the perceived quality of the displayed image.

Display systems may incorporate other image processing techniques besides applying a bit-depth floor to reduce visual artifacts and/or further reduce the amount of image data required to display an image. In some embodiments, a display system may use bit-depth assignment data that specifies one or more dithering algorithms for a particular region of an integral display. For example, the bit-depth assignment data may specify a spatially dithered bit depth for an indicated display region of the integral display. In this example, the spatially dithered bit depth may specify a particular bit depth for one set of display elements (e.g., a certain set of pixels and/or sub-pixels) within the indicated display region and a different bit depth for a different set of display elements within the indicated region. The spatially dithered bit depth may additionally specify further bit depths for further sets of display elements within the indicated region. These sets of display elements may be interspersed with each other according to an ordered dithering pattern.

Additionally or alternatively, the bit-depth assignment data may specify a temporally dithered bit depth for an indicated region of the integral display. This temporally dithered bit depth may specify, over a dithering period, a first bit depth for a subset of display elements within the indicated region for a particular subset of display frames that are displayed during the dithering period. The temporally dithered bit depth may also specify a second bit depth for the subset of display elements for a second subset of display frames within the dithering period. Additionally, the temporally dithered bit depth may include additional subsets of display frames as needed. These subsets of display frames may be interspersed with each other during the dithering period according to a predetermined dithering pattern. For example, the temporally dithered pattern may alternate displaying a frame from the first subset of display frames with displaying a frame from the second subset of display frames.

The above-described dithering processes may vary with the bit depth being used to drive a particular region of an integral display. For example, a display system may use little or no dithering for display regions being driven at a high bit depth while using significant dithering for display regions being driven at a low bit depth. Similarly, the display system may dither sub-pixels being driven at a low bit depth while not applying dithering to sub-pixels being driven at a high bit depth. Moreover, display systems may use a variety of forms of dithering. For example, a display system may use the above-described forms of bit-depth dithering. Additionally or alternatively, the display system may employ dithering algorithms that dither the hue, brightness, and/or saturation of pixels.

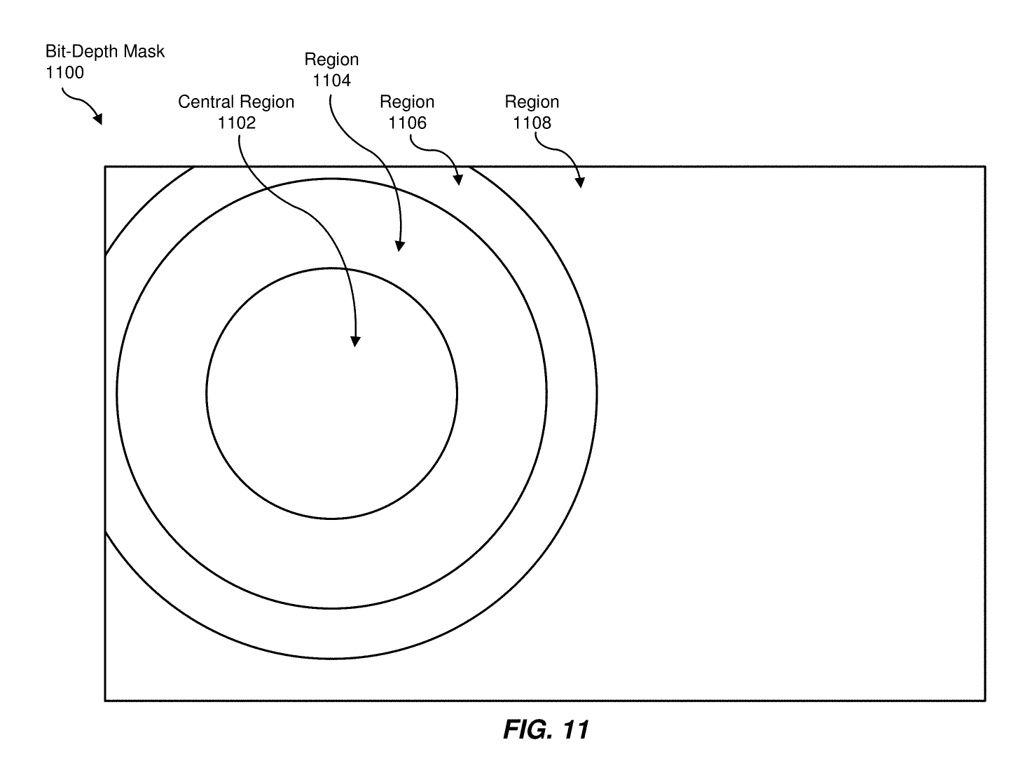

In embodiments where the display system includes a gaze-tracking element in conjunction with a bit-depth mask, the display system may reconfigure, translate, or otherwise alter the application of the bit-depth mask so that the central region of the bit-depth mask tracks with the direction of the user's gaze. FIG. 11 illustrates a bit-depth mask that has been adjusted so that the central region (i.e., the region with the highest bit depth) of the bit-depth mask corresponds with the direction of a user's gaze. Bit-depth mask 1100 generally represents the same pattern of regions as bit-depth mask 900. However, central region 1102 has been shifted up and to the left to track with the user's gaze. Regions 1104, 1106, and 1108 of bit-depth mask 1100 have also been shifted to remain concentric with central region 1102.

In some embodiments, the display system may predict the direction of the user's gaze to minimize or even eliminate lag time between the user looking at a region of an image and the display system shifting the region of high bit depth to match the direction of the user's gaze. For example, the display system may predict a future direction of the user's gaze based on image content and display image frames with high bit depth regions corresponding to the predicted gaze direction at the time that the user's gaze was predicted to be directed to that region of the display. In these examples, an image may contain regions, features, or other elements that are likely to attract a user's attention. For example, an application may flag a particular feature, such as a block of text or another visual element, as important. Additionally or alternatively, the display system may identify important regions based on changes in the visual content of those regions, contrast with surrounding regions, distinctive colors in those regions, and/or any other suitable method of identifying visually important regions. In some examples, the display system may identify a single region as the most important region of an image and use that region as a focal point of the image. Alternatively, the display system may identify multiple regions as potentially interesting and accordingly treat each identified region as a predicted gaze region. For example, the display system may determine that both the upper left corner and lower right corner of an image contain visually important content and accordingly treat both the upper left corner and the lower right corner as predicted gaze regions (e.g., by configuring regions both in the upper left corner and the lower right corner to display at high bit depths).

The display system may increase the bit depth used to display regions of the image that correspond to the predicted direction of the user's gaze and reduce the bit depth used to display other regions of the image according to those regions' distance from the predicted gaze regions. In some embodiments, the angular and/or temporal sensitivity of gaze-tracking elements may be sufficiently detailed enough to track micro saccades in the user's gaze. Tracking regions of high bit depth to these micro saccades may allow for display systems to reduce the size of high-bit-depth regions while preserving user perceptions of image quality.

In some examples, display systems may include multiple integral displays. For example, a display system may include two integral displays. These integral displays may be coupled to a head mount that, when worn by a user, holds one integral display in front of the user's left eye and the other integral display in front of the user's right eye. Display systems incorporating head-mounted displays may employ a variety of measures to ensure that the images presented via the displays properly simulates binocular vision. For example, the display system may provide separate bit-depth assignment data to each integral display, with the bit-depth assignment data for a given display tracking to the user's eye that corresponds to that display. Additionally or alternatively, the display system may adjust spatial and/or temporal dithering patterns to avoid presenting regions of mismatched bit depths to each of the user's eyes.

As described above, the apparatuses, systems, and methods described herein may employ a variety of techniques to display mixed bit-depth images. Display systems may combine dithering algorithms, bit-depth masks, and/or bit-depth floors as part of configuring displays to display mixed bit-depth images. As may be appreciated from these examples, the final mixed bit-depth images presented on a display may be generated in a variety of contexts. In some embodiments, a display system may apply one or more of these techniques to an image before the image data is encoded. For example, one or more of the systems described herein may provide bit-depth assignment data, bit-depth masks, and/or any other suitable information usable for generating a mixed bit-depth image to a rendering subsystem such as a graphics processing unit (GPU), thus causing the rendering subsystem to render images according to the desired bit-depth layout. Rendering images according to the desired bit-depth layout may benefit display systems by reducing the amount of image data that must be encoded for transfer to a display, reducing the amount of image processing that must be performed by the rendering subsystem to generate the images, and/or by eliminating the need for bit-depth assignment data to be transmitted and/or interpreted by a display device.

In further embodiments, a display system may apply one or more of the above-described bit-depth reduction techniques to the image data as the image data is being encoded. For example, a driver element may receive, identify, or otherwise determine bit-depth assignment data for an image and apply the bit-depth assignment data to the image as the image data is being encoded for transmission to a display device. The driver element may use purpose-built codecs as part of applying bit-depth assignment data to the image data. Applying bit-depth assignment data to images during encoding may benefit a display system by eliminating the need for specialized rendering subsystems and/or specialized rendering drivers while also reducing the total amount of image data transmitted to the display.

In additional embodiments, a display system may apply bit-depth reduction techniques to an image after the image data is decoded (e.g., at the integral display). For example, a head-mounted display may include a decoding codec that enables the head-mounted display to apply bit-depth assignment data to image data as the image data is decoded. Additionally or alternatively, the head-mounted display may apply the bit-depth assignment data based on gaze tracking and/or prediction data from gaze-tracking elements of the head-mounted display. Applying bit-depth assignment data at a display in this manner may benefit a display system by incorporating both the bit-depth reduction systems and the display systems within a single device. This encapsulation may allow for plug-and-play display devices that display mixed bit-depth images to be added to any relevant computing system such as home computers, game consoles, and/or virtual reality systems. Such plug-and-play devices may reduce the amount of image data being used to drive the display devices while maximizing user convenience.

FIG. 12 is a block diagram of an example system 1200 for displaying mixed bit-depth images. In the example of FIG. 12, a computing device 1202 may act as a controller for a head-mounted display 1206. Computing device 1202 may generally represent any computing device that is capable of processing and transmitting image frames, video frames, and/or any other form of visual content that may be presented on a display. Head-mounted display 1206 may generally represent any suitable display or combination of displays that incorporates a head mount that holds the display(s) in front of a user's eyes.

Computing device 1202 may incorporate a driver element 1116 that uses codecs 1118 to process image 1122. Driver element 1116 may use any combination of the above-described bit-depth reduction methods, dithering algorithms, etc. as part of processing image 1122 for display on one or more integral displays of head-mounted display 1206. Image 1122 may generally represent any suitable visual medium, such as stationary images, video frames, and the like. For example, driver element 1116 may, based on preconfigured information and/or information in codecs 1118, apply a bit-depth mask and/or a dithering algorithm to all or a portion of image 1122. In some embodiments, driver element 1116 may receive gaze-tracking and/or gaze-prediction information from other elements of computing device 1202 and/or head-mounted display 1206. Driver element 1116 may adjust any applied bit-depth masks, dithering algorithms, bit-depth assignment layouts, and the like to ensure that regions of high bit depth correspond with the direction of the user's gaze and that regions of low bit depth are displayed in the periphery of the user's field of view.

Once driver element 1116 has processed image 1122, driver element 1116 may provide the result to output adapters 1120 for transfer, over interface 1212, to head-mounted display 1206. Interface 1212 may generally represent any suitable form of transferring digital information from one electronic device to another, such as physical cables, radio connections, optical connections, and/or any other suitable transmission medium. Driver element 1116 may include bit-depth assignment data in the processed data provided to output adapters 1120.

Head-mounted display 1206 may receive the image data at reception element 1224. Configuration element 1208 may use bit-depth assignment data received at reception element 1224 as part of configuring integral display 1210 of head-mounted display 1206 to display image 1122. Once configuration element 1208 has configured integral display 1210 to display image 1122, head-mounted display 1206 may present image 1122 on integral display 1210.

In some embodiments, the system may include a bit-reduction element that receives image 1122 and reduces all or a portion of image 1122 according to bit-depth assignment data generated by driver element 1116 to have varying bit depths. The bit-reduced version of image 1122 may have a smaller data size than the original version of image 1122.

Elements of computing device 1202 may then provide this bit-reduced version of image 1122 to reception element 1224 of head-mounted display 1206 for display on integral display 1210. The bit-reduction element may reduce image 1122 in a variety of contexts.

In some embodiments, the bit-reduction element may reduce image 1122 before transmitting image 1122 to head-mounted display 1206. For example, the bit-reduction element may reduce image 1122 after image 1122 has been rendered by a rendering subsystem of computing device 1202 but before image 1122 is encoded for transmission to head-mounted display 1206. In this example, reducing image 1122 before encoding may reduce the amount of image data that must be handled at all downstream steps of presenting image 1122 to a user. Specifically, reducing image 1122 prior to encoding image 1122 may reduce the amount of image data that must be processed during encoding, transmission, decoding, and/or driving of integral display 1210.

Additionally or alternatively, the bit-reduction element may reduce image 1122 after encoding but before transmission to head-mounted display 1206. For example, the bit-reduction element may determine that the encoded data includes more image data than is strictly required to maintain image quality on integral display 1210 and reduce the encoded data. Reducing the encoded version of image 1122 prior to transmission may reduce the amount of image data that must be transmitted, decoded, and/or used to drive integral display 1210.

In embodiments where a rendering subsystem applies some or all of the bit-depth assignment data to image 1122, the bit-reduction element may determine whether image 1122 needs to be reduced. For example, the bit-reduction element may be configured to ensure that driver element 1116 only processes image frames of a specified size or less. In this example, if the rendered version of image 1122 includes the specified amount of image data or less, the bit-reduction element may simply forward image 1122 to driver element 1116. On the other hand, if the rendered version of image 1122 exceeds the data-size threshold, the bit-reduction element may reduce image 1122 to satisfy the data-size threshold.

In some embodiments, the bit-reduction element may be configured with an opportunistic algorithm that determines whether reducing image 1122 would result in sufficient data-size and/or other efficiency changes to overcome the additional processing requirements of reducing image 1122. For example, the opportunistic algorithm may determine that reducing image 1122 would consume an amount of processing resources (such as processor cycles and/or battery power) that would not be recovered by the savings afforded by the data-size reduction achieved by the transformation. Additionally or alternatively, the opportunistic algorithm may determine that the reducing image 1122 to satisfy any applicable data-size and/or efficiency thresholds would result in an unacceptable level of quality loss in the version of image 1122 presented on integral display 1210. In these examples, the opportunistic algorithm may prevent the bit-reduction element from reducing image 1122 and/or impose a bit-reduction floor on the bit-reduction element to prevent unacceptable losses of image quality at integral display 1210.

FIG. 13 is a flow diagram of an example method 1300 for assembling the above-described system. At step 1310 of method 1300, the method may include coupling a reception to a display element. The reception element may be configured to receive bit-depth assignment data that specifies differing bit depths for corresponding display regions of the display element, and the display element may be configured to display mixed bit-depth images according to the bit-depth assignment data.

At step 1320 of method 1300, the method may include establishing a communicative connection between the reception element and a driver element. The driver element may generate the above-described bit-depth assignment data by configuring differing bit depths for corresponding regions of the mixed bit-depth images.

At step 1330 of method 1300, the method may include coupling the display element and the reception element to a configuration element. The configuration element may, as shown in step 1330(A), configure the display element to display the mixed bit-depth images according to an arrangement of regions specified by the bit-depth assignment data. Additionally, and as shown in step 1330(B) of method 1330, the configuration element may reconfigure the display element based at least in part on receiving updated bit-depth assignment data from the driver element. The configuration element may reconfigure the display element to display the mixed bit-depth images according to an updated arrangement of regions specified by the updated bit-depth assignment data.

In embodiments where the system includes a head mount, method 1300 may include coupling the head mount to the display elements such that the head mount holds the display element within a user's field of view. Moreover, in embodiments where the system includes a gaze-tracking element, method 1300 may include establishing a communicative connection between the driver element and the gaze-tracking element. In these embodiments, the driver element may generate the bit-depth assignment data based at least in part on the direction of the user's gaze.

As described above, a head-mounted display may be configured to display mixed bit-depth images to a user. A computing device, such as a game console, may render images using various bit depths for different regions of the images, thereby reducing the amount of data that must be transmitted to a connected head-mounted display. The arrangement and designated bit depths of each image region may be based on a predetermined bit-depth mask that is adjusted based on the direction of the user's gaze, ensuring that the region of maximum bit depth is positioned within the center of the user's field of view. Regions that are farther away from this central region may be rendered at a correspondingly lower bit depth. The computing device may then provide this reduced and/or mixed bit-depth image to the head-mounted display (e.g., a VR headset). Additionally or alternatively, the computing device may provide bit-depth assignment data to the head-mounted display, thereby instructing the head-mounted display to drive corresponding groups of pixels at the bit depths designated in the bit-depth assignment data. By providing display devices with mixed bit-depth images and/or with bit-depth assignment data in this manner, the apparatuses, systems, and methods described herein may reduce the overall amount of data that must be processed and/or transmitted to display images to users. Reducing the amount of data to be processed and/or transmitted may maintain user perception of image quality while reducing heat production, rendering lag, and other undesirable aspects that may arise from handling large volumes of image data.

Embodiments of the instant disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An apparatus comprising:
a display device comprising an integral display that:
receives bit-depth assignment data that specifies differing bit depths for corresponding display regions of the integral display;
configures, based on the bit-depth assignment data, the integral display to display image data at the differing bit depths within the corresponding display regions of the integral display, thereby causing the display device to:
consume a lower proportion of image data to drive a display region of the integral display configured to display image data at a lower bit depth; and
maintain higher image quality within a display region of the integral display configured to display image data at a higher bit depth; and
reconfigures the integral display in response to receiving updated bit-depth assignment data.

2. The apparatus of claim 1, further comprising a gaze-tracking element that:
determines a direction of a user's gaze as the user views the display device; and
provides, based at least in part on the direction of the user's gaze, the updated bit-depth assignment data.

3. The apparatus of claim 2, wherein the gaze-tracking element contributes to the bit-depth assignment data to specify that a first bit depth for a first display region of the integral display is higher than a second bit depth for a second display region of the integral display based at least in part on the gaze-tracking element determining that the user's gaze is closer to the first display region than to the second display region.

4. The apparatus of claim 1, wherein a display region of the integral display configured to display image data at the lower bit depth comprises a region that is adjacent to and concentric with a display region configured to display image data at the higher bit depth.

5. The apparatus of claim 1, wherein the display device reconfigures the integral display based at least in part on a predetermined bit-depth mask that specifies a predetermined bit depth for each display region.

6. The apparatus of claim 1, wherein:
the bit-depth assignment data specifies a granular bit depth for an indicated display region of the integral display, wherein the granular bit depth specifies:
a first sub-pixel bit depth for a first category of sub-pixels in the indicated display region; and
a second sub-pixel bit depth for a second category of sub-pixels in the indicated display region, wherein the second sub-pixel bit depth is different from the first sub-pixel bit depth.

7. The apparatus of claim 1, wherein:
the bit-depth assignment data specifies a spatially dithered bit depth for an indicated display region of the integral display, wherein the spatially dithered bit depth specifies:
a first bit depth for a first subset of display elements within the indicated display region; and
a second bit depth for a second subset of display elements within the indicated display region, wherein the second bit depth is different from the first bit depth and wherein the second subset of display elements are interspersed among the first subset of display elements according to an ordered dithering pattern.

8. The apparatus of claim 1, wherein:
the bit-depth assignment data specifies a temporally dithered bit depth for an indicated display region of the integral display, wherein the temporally dithered bit depth specifies, over a dithering period:
a first bit depth for a subset of display elements within the indicated display region within a first subset of display frames displayed during the dithering period; and
a second bit depth for the subset of display elements within the indicated display region within a second subset of display frames displayed during the dithering period, wherein the second subset of display frames are interspersed with the first subset of display frames during the dithering period according to a dithering pattern.

9. A system comprising:
a display device comprising an integral display that is configured to display mixed bit-depth images to a user;
a driver element that generates bit-depth assignment data that specifies differing bit depths for corresponding display regions of the integral display;
a reception element, communicatively coupled to the display device, that receives the bit-depth assignment data; and
a configuration element, communicatively coupled to the display device and the reception element, that configures, based at least in part on the bit-depth assignment data, the integral display to display image data at the differing bit depths within the corresponding display regions of the integral display, thereby causing the display device to:
consume a lower proportion of image data to drive a display region of the integral display configured to display image data at a lower bit depth; and
maintain higher image quality within a display region of the integral display configured to display image data at a higher bit depth; and
reconfigures the integral display in response to receiving updated bit-depth assignment data.

10. The system of claim 9, further comprising a gaze-tracking element that:
identifies, based at least in part on a direction of a user's gaze, a focal region on the display device that represents a central region of the user's field of view as the user views the display device; and
provides, to the driver element, information that describes a location of the focal region on the display device.

11. The system of claim 10, wherein the gaze-tracking element contributes to the bit-depth assignment data to specify that a first bit depth for a first display region of the integral display is higher than a second bit depth for a second display region of the integral display based at least in part on the gaze-tracking element determining that the user's gaze is closer to the first display region than to the second display region.

12. The system of claim 9, wherein a display region of the integral display configured to display image data at the lower bit depth comprises a region that is adjacent to and concentric with a display region configured to display image data at the higher bit depth.

13. The system of claim 9, wherein:
the bit-depth assignment data specifies a granular bit depth for an indicated display region of the integral display, wherein the granular bit depth specifies:
a first sub-pixel bit depth for a first category of sub-pixels in the indicated display region; and
a second sub-pixel bit depth for a second category of sub-pixels in the indicated display region, wherein the second sub-pixel bit depth is different from the first sub-pixel bit depth.

14. The system of claim 9, wherein:
the bit-depth assignment data specifies a spatially dithered bit depth for an indicated display region of the integral display, wherein the spatially dithered bit depth specifies:
a first bit depth for a first subset of display elements within the indicated display region; and
a second bit depth for a second subset of display elements within the indicated display region, wherein the second bit depth is different from the first bit depth and wherein the second subset of display elements are interspersed among the first subset of display elements according to an ordered dithering pattern.

15. The system of claim 9, wherein:
the bit-depth assignment data specifies a temporally dithered bit depth for an indicated display region of the integral display, wherein the temporally dithered bit depth specifies, over a dithering period:
a first bit depth for a subset of display elements within the indicated display region within a first subset of display frames displayed during the dithering period; and
a second bit depth for the subset of display elements within the indicated display region within a second subset of display frames displayed during the dithering period, wherein the second subset of display frames are interspersed with the first subset of display frames during the dithering period according to a dithering pattern.

16. The system of claim 9, further comprising a bit-reduction element that:
receives an original image for display by the display device; and
reduces the original image to have varying bit depths according to the bit-depth assignment data before transmitting the reduced image to the display device, wherein a data size of the reduced image is less than a data size of the original image.

17. The system of claim 9, further comprising:
a second integral display; and
a head mount coupled to the integral display and to the second integral display that, when worn by a user, holds the integral display in front of the user's left eye and holds the second integral display in front of the user's right eye.

18. A method comprising:
coupling, to a display element that is configured to display mixed bit-depth images, a reception element that is configured to receive bit-depth assignment data that specifies differing bit depths for corresponding display regions of the display element;
establishing a communicative connection between the reception element and a driver element that generates the bit-depth assignment data by configuring differing bit depths for corresponding regions of the mixed bit-depth images;
coupling the display element and the reception element to a configuration element that:
configures, based at least in part on the bit-depth assignment data, the display element to display the mixed bit-depth images according to an arrangement of regions specified by the bit-depth assignment data; and
reconfigures, based at least in part on the reception element receiving updated bit-depth assignment data from the driver element, the display element to display the mixed bit-depth images according to an updated arrangement of regions specified by the updated bit-depth assignment data.

19. The method of claim 18, further comprising coupling a head mount to the display element that, when worn by a user, holds the display element within a user's field of view.

20. The method of claim 19:
further comprising establishing a communicative connection between the driver element and a gaze-tracking element that determines a direction of a user's gaze as the user views images displayed by the display element; and
wherein the driver element generates the bit-depth assignment data based at least in part on the direction of the user's gaze.
